(19) United States
(12) Patent Application Publication
(10) Pub. No.: US 2026/0010565 A1
(43) Pub. Date: Jan. 8, 2026

(54) Search Results With Result-Relevant Highlighting

(71) Applicant: Google LLC., Mountain View, CA (US)

(72) Inventors: Brian Edmond Brewington, Superior, CO (US); Carl Staaf, Seattle, WA (US)

(21) Appl. No.: 19/324,373

(22) Filed: Sep. 10, 2025

Related U.S. Application Data
(63) Continuation of application No. 17/622,067, filed on Dec. 22, 2021, now abandoned.
Application No. 17/622,067 is a continuation of application No. PCT/US2020/067300, filed on Dec. 29, 2020.

(51) Int. Cl. G06F 16/538; G01C 21/36; G06F 16/587

(52) U.S. Cl. CPC G06F 16/538; G01C 21/3679; G06F 16/587

(57) ABSTRACT

The technology relates to providing visually-verifiable metadata in response to a query. A query may be sent from an application. In response to the query visually-verifiable metadata corresponding to one or more points of interest relevant to the query and an image associated with the visually-verifiable metadata may be received. The image associated with the visually-verifiable metadata may be displayed and the visually-verifiable metadata may be annotated within the displayed image.

### CROSS-REFERENCE TO RELATED APPLICATIONS

This application is a continuation of U.S. application Ser. No. 17/622,067, filed on Dec. 22, 2021, which is a national phase entry under 35 U.S.C. § 371 of International Application No. PCT/US2020/067300, filed on Dec. 29, 2020, the disclosures of which are incorporated herein by reference.

### BACKGROUND

Map applications have historically provided representations of geographic areas and directions between locations. Modern map applications provide additional information and services beyond those historically provided, such as satellite imagery, street level imagery, user-provided imagery, virtual tours of locations, business listings, business information, three-dimensional models of locations, real-time navigation, and real-time traffic conditions amongst other information and services. Map applications, and other applications that incorporate map application features, such as virtual assistants, may provide any of this information and services to users when requested. However, it may be difficult for users to trust that the information provided to them is accurate without first understanding where the information came from. Users may try to verify the information before relying on it, such as by looking at street level imagery which can be disorienting to users if they have never visited a particular location. Moreover, the information provided to the users may be difficult and time-consuming to locate within the provided imagery

### SUMMARY

Aspects of this disclosure provide visually-verifiable metadata about points of interest. One aspect of the disclosure is directed to a method for providing metadata in an application. The method includes sending, by one or more processors, a query from the application; receiving, by the one or more processors, in response to the query, visually-verifiable metadata corresponding to one or more points of interest relevant to the query and an image associated with the visually-verifiable metadata; and displaying, by the one or more processors in the application, the image associated with the visually-verifiable metadata, wherein the visually-verifiable metadata is annotated within the image.

Another aspect of the disclosure is directed to a system comprising one or more processors. The one or more processors are configured to send a query from an application; receive, in response to the query, visually-verifiable metadata corresponding to one or more points of interest relevant to the query and an image associated with the visually-verifiable metadata; and display, in the application, the image associated with the visually-verifiable metadata, wherein the visually-verifiable metadata is annotated within the image.

Another aspect of the disclosure is directed to a non-transitory computer-readable storage medium storing instructions executable by one or more processors for performing a method, comprising sending a query from an application; receiving, in response to the query, visually-verifiable metadata corresponding to one or more points of interest relevant to the query and an image associated with the visually-verifiable metadata; and displaying, in the application, the image associated with the visually-verifiable metadata, wherein the visually-verifiable metadata is annotated within the image.

In some instances the image includes imagery of the one or more points of interest.

In some instances, prior to displaying the image, a request for verification of the visually-verifiable metadata is received, wherein the image is displayed in response to the request.

In some instances, the application includes a selectable input, wherein the request for verification is received through the selectable input.

In some instances, annotated visually-verifiable metadata is highlighted, circled, identified, outlined, or enlarged within the image.

In some instances, the application is a navigation application and the query is a destination. In some examples, the application includes a search interface, wherein the query is received through the search interface and the image and visually-verifiable metadata is displayed within the search interface.

### BRIEF DESCRIPTION OF THE DRAWINGS

FIG. 1 is a functional diagram of an example system in accordance with aspects of the disclosure.

FIG. 2 is a pictorial diagram of the example system of FIG. 1.

FIG. 3 is an example of a database stored in a storage system in accordance with aspects of the disclosure.

FIG. 4 is a flow diagram illustrating the creation of a database in accordance with aspects of the disclosure.

FIG. 5 is an example image with identified objects and text in accordance with aspects of the disclosure.

FIG. 6 is a flow diagram illustrating the identification and providing of metadata in response to a query in accordance with aspects of the disclosure.

FIG. 7 is an image illustrating an example use case of the technology within a map application in accordance with aspects of the disclosure.

FIG. 8 is an image illustrating another example use case of the technology in accordance with aspects of the disclosure.

FIG. 9 is an image illustrating an example use case of the technology within a navigation application in accordance with aspects of the disclosure.

FIG. 10 is an image illustrating an example use case of the technology providing visually-verifiable metadata in response to a query for a POI that satisfies a category in accordance with aspects of the disclosure.

FIGS. 11A and 11B illustrate an example use case of the technology within a search interface in accordance with aspects of the disclosure.

### DETAILED DESCRIPTION

The technology described herein provides visually-verifiable metadata about points of interest. In this regard, when a query is made to a map application or other such application that provides map information or services, the application may return data that includes relevant metadata about one or more points of interest in response to the query. Such applications may be referred to as map applications, applications, or apps herein. To increase a user's confidence that the metadata provided in response to a query is accurate, visual verification of the metadata may be provided or otherwise made available to the user, such as by providing an image that includes the metadata.

The visually-verifiable metadata may be provided in one or more images of the one or more points of interest and the metadata may corroborate the information returned in response to the query. For instance, in response to a query for a business, metadata that includes information associated with the business may be provided to the user. This metadata may include information such as the street number. In addition to the metadata provided to the user, an image of the business showing the street number on a wall of the business may also be provided. The street number within the image is visually-verifiable metadata that provides visual evidence to the user that the street number in the metadata is accurate. In another example, the metadata provided in response to a query may include the operating hours of the business. The operating hours metadata may be visually-verifiable within an image having the operating hours of the business printed on a door of the business. The portions of the images that are relied upon as verifying the metadata may be highlighted, circled, or otherwise identified to emphasize the information contained in the metadata and guide the user to the relevant portion of the image.

### Example Systems

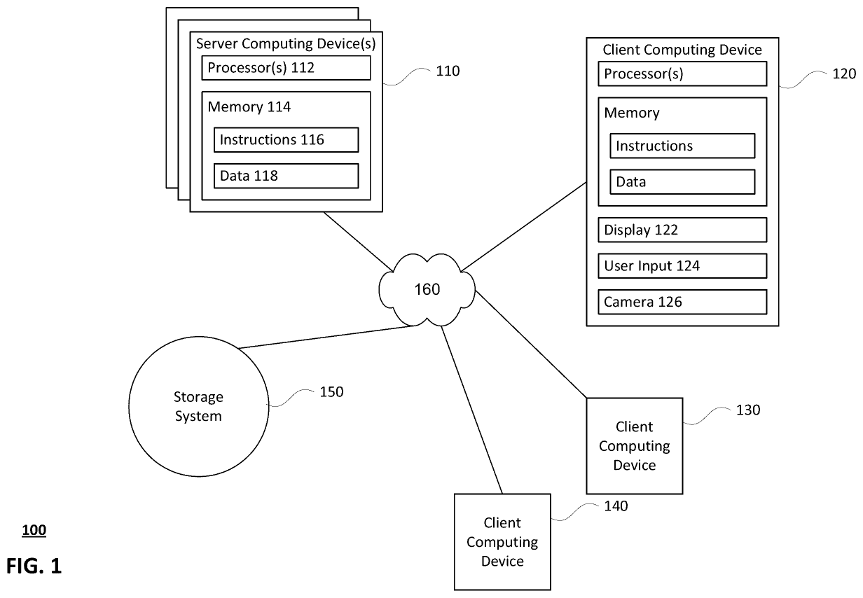

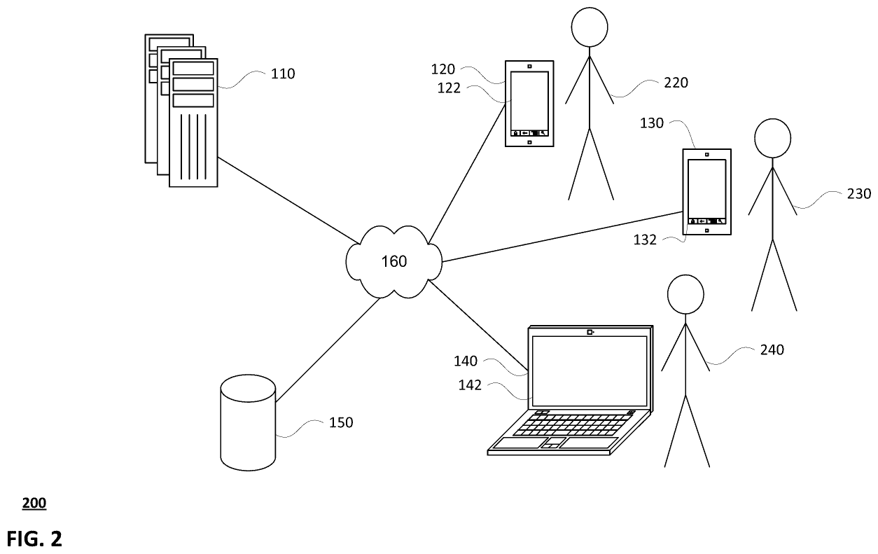

FIGS. 1 and 2 illustrate an example system 100 in which the features described above may be implemented. It should not be considered as limiting the scope of the disclosure or usefulness of the features described herein. In this example, system 100 can include computing devices 110, 120, 130, and 140 as well as storage system 150. Each of the computing devices 110-140 can contain one or more processors 112, memory 114 and other components typically present in general-purpose computing devices. Memory 114 of each of computing device 110-140 can store information accessible by the one or more processors 112, including instructions 116 that can be executed by the one or more processors 112.

Memory can also include data 118 that can be retrieved, manipulated or stored by the processor. The memory can be of any type, optionally a non-transitory type, capable of storing information accessible by the processor, such as a hard-drive, memory card, ROM, RAM, DVD, CD-ROM, write-capable, and read-only memories.

The instructions 116 can be any set of instructions to be executed directly, such as machine code, or indirectly, such as scripts, by the one or more processors. In that regard, the terms “instructions,” “application,” “steps,” and “programs” can be used interchangeably herein. The instructions can be stored in object code format for direct processing by a processor, or in any other computing device language including scripts or collections of independent source code modules that are interpreted on demand or compiled in advance. Functions, methods, and routines of the instructions are explained in more detail below.

Data 118 may be retrieved, stored or modified by the one or more processors 112 in accordance with the instructions 116. For instance, although the subject matter described herein is not limited by any particular data structure, the data can be stored in computer registers, in a relational database as a table having many different fields and records, or XML documents. The data can also be formatted in any computing device-readable format such as, but not limited to, binary values, ASCII or Unicode. Moreover, the data can comprise any information sufficient to identify the relevant information, such as numbers, descriptive text, proprietary codes, pointers, references to data stored in other memories such as at other network locations, or information that is used by a function to calculate the relevant data.

The one or more processors 112 can be any conventional processors, such as a commercially available CPU. Alternatively, the processors can be dedicated components such as an application specific integrated circuit (“ASIC”) or other hardware-based processor. Although not necessary, one or more of computing devices 110-140 may include specialized hardware components to perform specific computing processes and functions, such as decoding video, matching video frames with images, distorting videos, encoding distorted videos, machine learning, machine perception, logo recognition, visual text transcription, semantic segmentation, and other such processes and machine learning faster or more efficiently.

Although FIG. 1 functionally illustrates the processor, memory, and other elements of computing devices 110 and 120 as being within the same block, respectively, the processor, memory, and other elements can actually comprise multiple processors, memories, or other elements that may or may not be stored within the same physical housing. For example, the memory 114 of server computing device 110 can be a hard drive or other storage media, such as RAM, located in one or more housings different from that of the other components of server computing device 110, such as processors 112. Accordingly, references to a processor, memory, or other elements of the computing devices will be understood to include references to a collection of processors, memories, or elements that may or may not operate in parallel. Moreover, each computing device may be comprised of multiple computing devices. For example, each server computing device 110 may include multiple server computing devices operating as a load-balanced server farm, distributed system, etc. Yet further, although some functions described below are indicated as taking place on a single computing device having a single processor, various aspects of the subject matter described herein can be implemented by a plurality of computing devices, for example, communicating information over network 160, as described herein.

Each of the computing devices 110, 120, 130, and 140 can be at different nodes of a network 160 and capable of directly and indirectly communicating with other nodes of network 160. Although only computing devices 110, 120, 130, and 140 are depicted in FIGS. 1-2, it should be appreciated that fewer or more computing devices may be possible. In this regard, a typical system can include a large number of connected computing devices, with each different computing device being at a different node of the network 160.

The network 160 and intervening nodes described herein can be interconnected using various protocols and systems, such that the network can be part of the Internet, World Wide Web, intranets, wide area networks, or local networks. The network can utilize standard communications protocols and systems, such as Ethernet, Wi-Fi and HTTP, protocols that are proprietary to one or more companies, and various combinations of the foregoing. Although certain advantages are obtained when information is transmitted or received as noted above, other aspects of the subject matter described herein are not limited to any particular manner of transmission of information.

As an example, each server computing device 110 may include one or more servers capable of communicating with storage system 150 as well as computing devices 120, 130, and 140 via the network. For example, one or more of server computing devices 110 may use network 160 to transmit and present information to a user, such as user 220, 230, or 240, on a display, such as displays 122, 132, or 142 of computing devices 120, 130, or 140. In this regard, computing devices 120, 130, and 140 may be considered client computing devices and may perform all or some of the features described herein.

Each of the client computing devices 120, 130, and 140 may be configured similarly to the server computing devices 110, with one or more processors, memory and instructions as described above. Each client computing device 120, 130, or 140 may be a personal computing device intended for use by a user 220, 230, 240, and have all of the components normally used in connection with a personal computing device such as a central processing unit (CPU), memory (e.g., RAM and internal hard drives) storing data and instructions, a display such as displays 122, 132, or 142 (e.g., a monitor having a screen, a touch-screen, a projector, a television, or other device that is operable to display information), and user input device 124 (e.g., a mouse, keyboard, touch-screen, or microphone). The client computing device may also include a camera for recording video streams and/or capturing images, speakers, a network interface device, and all of the components used for connecting these elements to one another. Server computing device 110 may also include some or all of the components normally used in connection with a personal computing device.

Although the client computing devices 120, 130, and 140 may each comprise a full-sized personal computing device, they may alternatively comprise mobile computing devices capable of wirelessly exchanging data with servers over a network such as the Internet. By way of example only, client computing devices 120, 130 may be a mobile phone and client computing device may be a laptop. In some instances, client computing device 120, 130, and 140 may be a device such as a wireless-enabled PDA, a tablet PC, a netbook, a head-mounted computing systems, or any other such computing device. As an example the user may input information using a small keyboard, a keypad, microphone, using visual signals with a camera, or a touch screen.

As with memory 114, storage system 150 can be of any type of computerized storage capable of storing information accessible by the server computing devices 110, such as a hard-drive, memory card, ROM, RAM, DVD, CD-ROM, write-capable, and read-only memories. In addition, storage system 150 may include a distributed storage system where data is stored on a plurality of different storage devices which may be physically located at the same or different geographic locations. Storage system 150 may be connected to the computing devices via the network 160 as shown in FIG. 1 and/or may be directly connected to any of the computing devices 110, 120, 130, and 140 (not shown).

Storage system 150 may store data related to points of interest (POI) for retrieval in response to queries for information regarding points of interests as described herein. As used herein, points of interests may include any place or location, or objects at places or locations. Examples of a POI include businesses, such as restaurants, shops, or service providers such as mechanic auto shops, hotels, gas stations, and electric vehicle charging stations. Additional examples include natural landmarks, parks, public service providers such as police stations or post offices, and civil service locations, such as a municipal building. Other examples of POIs include signage of any kind, including road and traffic signs, addresses, street names, parking indications, retail signs, banners etc. Moreover, POIs can include any real-world entity with a physical address, including non-business structures such as residences.

In some instances, a POI can be associated with more than a singular location, such as latitude/longitude coordinates. In this regard, POIs may be associated with many locations or, in some instances, 3D geometry. In this regard, POIs may not be points, but may include many locations, such as, for example, a business occupying a building, part of a building, or entire grounds. Further, POIs can be parts of larger, aggregating POIs. For example, each store in a mall may constitute a respective POI, and the mall may be a POI that aggregates each store in the mall.

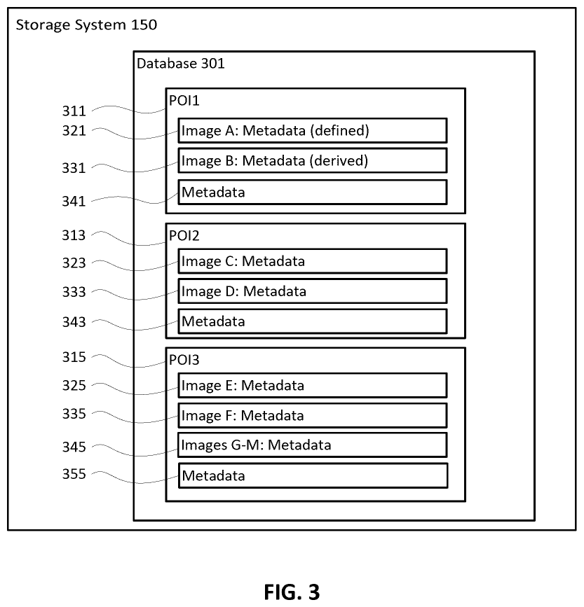

An example of data stored by storage system 150 is shown in FIG. 3. Storage system 150 includes database 301. Although database 301 is shown as being stored in storage system 150, the database 301, or other such storage structures may be stored in any computing device, including anyone of computing devices 110-140. Alternatively or additionally, the database 301, other such storage structures, may be stored across multiple computing devices or storage systems. In this regard, portions of database 301 may be stored on different storage devices and/or computing devices. Database 301 may be formed from two or more smaller databases.

Database 301 stores images and metadata that may be provided by an application, such as a mapping application in response to a query. Metadata may include any data that may be relevant to one or more points of interest or other such data that contains information that may be provided by a map application or other such application that provides map information or services, in response to a query. For example, metadata may include image data, such as satellite imagery, street level imagery, user-provided imagery, as well as other data such as virtual tours of locations, business listings, business information, three-dimensional models of locations, real-time navigation, and real-time traffic conditions amongst other information and services. Thus, image data may be considered metadata, but for purposes of clarity, image data is referred to as being distinct from other types of metadata herein.

Database 301 includes entries for three points of interest including POI1 311, POI2 313, and POI3 315. Each entry for a POI may include sub-entries in which image data and/or metadata associated with, or otherwise relevant to, the POI entry may be stored. For instance, the entry for POI1 311 includes sub-entries 321, 331, and 341. Sub-entries 321 and 331 store image data including Image A and Image B, respectively. The entry for POI2 313 includes sub-entries 323, 333, and 343. Sub-entries 323 and 333 store image data including Image C 323 and Image D 333, respectively. The entry for POI3 315 includes sub-entries 325, 335, 345, and 355. Sub-entries 325, 335, and 345 store image data including Image E, Image F, and a collection of images, Images G-M, respectively. Sub-entries 341, 343, and 355 store other metadata that is not defined or derived from an image, as detailed herein. Although each POI entry 311, 313, 315 includes a single metadata sub-entry 341, 343, 355, respectively, any number of metadata sub-entries entries may be included in each POI entry. Moreover, any number of image data sub-entries may be included in each POI entry.

Database 301 illustrates discrete POI entries for each individual POI, although sets of POIs may be grouped together in a single POI entry or a hierarchy of POI entries. For example, a POI may contain many other POIs. For example, a park POI may include other POIs within it, such as a walking path, statue, dog park, etc. In some instances, some or all of the POIs within the park may be grouped together as a single POI entry for the park.

In some instances, POI entries may be stored hierarchically. For example, a park POI may contain other POIs, such as a splash park and dog park located within the park. The splash park may contain additional POIs such as slides and fountains and the dog park may additional POIs such as an obstacle course and benches. To capture the relationship of the different areas within the park, the POIs can be organized hierarchically. In this regard, the park POI entry may be the top-level of the hierarchy, with the splash park POI entry and dog park POI entry being mid-level POI entries, under the park POI entry. Each slide POI entry and fountain POI entry may be stored under the splash park POI entry. Similarly, the obstacle course POI entry and bench POI entry may be stored under the dog park POI entry. Although the hierarchy of entries is described from the top down, the hierarchy may be reversed. For example, the park POI entry may be the lowest layer of the hierarchy.

In some instances, the hierarchical relationship between POI entries may be defined through other data. In this regard, the relationship between POI entries may be stored in a separate portion of the database 301 or in another database entirely. In this regard, the POI entries may be stored at the same level in the database, with the hierarchical relationship between the POI entries being described through other data.

Each entry for a POI may include sub-entries in which image data and/or metadata associated with, or otherwise relevant to, the POI entry may be stored. Image data within a sub-entry may include one or more images of the POI associated with the sub-entry. In some instances, image data within a sub-entry may include images that contain imagery associated with the POI for which the image data-subentry is stored. For instance, the image data for a POI may include a photo of an object and/or individual captured at, or near the POI, or any other images which may have some association or relation with the POI. As used herein, images may include photographs, screenshots, videos, including video clips and/or video stills/frames, or any other such visual data including actively-lit or passive non-visible band imagery such as LiDAR, radar, or infrared, taken from any perspective, such as ground level, aerial, satellite, etc. In this regard, images may be captured by cameras, video cameras, sensors, such as LiDAR, radar, and infrared sensors, or other such devices.

The metadata may include information about the image data within each sub-entry. The metadata within each sub-entry may be based on data corresponding to the image data within the sub-entry. For example, image data may include data such as the time and location the image or images within the image data were captured. The time and location may be stored as metadata within the sub-entry. Metadata based on data from the image data may be considered defined metadata. In some instances, and as further described herein, the metadata within each sub-entry may be derived or otherwise generated from the image data within the sub-entry. Metadata generated from the image data may be considered derived metadata. Metadata may also include data that is associated with a POI, but not derived or defined from image data.

Metadata may be stored within sub-entries in the database 301. For instance, and referring to FIG. 3, sub-entry 321 within the entry for POI1 311 includes metadata associated with Image A. In some instances, metadata associated with a POI, but not associated with image data may be stored in separate sub-entries, such as sub-entries 341, 343, 355, as further shown in FIG. 3.

Although FIG. 3 illustrates each entry as including unique sub-entries, in some instances a sub-entry may be associated with two or more entries and/or the same sub-entries may be stored in two or more entries. For instance, a photo that captures imagery of POI1 and POI2 may be stored in a sub-entry within the entry for POI1 311 and again as a sub-entry within the entry for POI2 313.

Alternatively, a photo that captures imagery of POI1 and POI2 may be stored as a sub-entry within one of the POI entries. A link or association to the sub-entry may be stored in the other POI entry. In another example, a sub-entry may be associated with both entries, including the entry for POI1 311 and the entry for POI2. In this regard, sub-entries may be stored outside of entries or in a separate database. By using a link or association, a sub-entry may be stored once, thereby negating the need to store multiple copies of the same sub-entry.

Database 301 is one example of a storage structure capable of storing data related to points of interest and is described herein for reference. In operation, any storage structure which allows for image data and metadata to be stored in association with a POI entry may be used. For example, image data and metadata may be stored in separate databases than POI entries. The image data and metadata may include, or otherwise be associated with, pointers that link the image data and metadata to particular POIs. In some instances, defined and/or derived metadata may be stored in separate databases than the image data. The defined and/or derived metadata may include, or otherwise be associated with, pointers that link each piece of defined and/or derived metadata to the image data, image, and/or images from which it was gathered or otherwise generated from.

### Example Methods

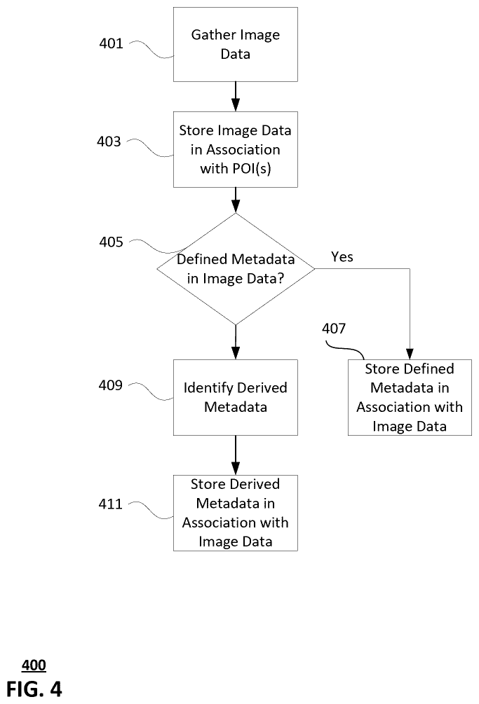

FIG. 4 is a flow diagram 400 that illustrates the process for gathering and indexing image data by a server computing device, such as server computing device 110, to provide to users in response to queries, such as those submitted to a map application. In this regard, image data may be gathered from sources, as shown in block 401. Gathering image data may be done automatically or manually. For instance, a user may upload image data from a computing device, such as one of computing devices 120-140, to server computing device 110 or storage system 150. In another example, image data collected in the field, such as with a navigation car fitted with cameras, may be uploaded to server computing device 110 or storage system 150. Alternatively, or in combination with the manual collection of image data, automatic collection of image data may be performed, such as by a web crawler installed on server computing device 110. In some instances, the creators or owners of image data may provide copies of the image data content directly to the server computing device. Permission to retrieve image data, manually or automatically, may be provided by the owners or handlers of the image data prior to retrieval of the image data.

Each piece of gathered image data may be stored as sub-entry of a POI entry for which the image data has an association or relation as shown in block 403. For example, and referring to FIG. 3, “Image A” may contain imagery of POI1. As such, Image A is stored as a sub-entry 321 of entry 311 representative of POI1. In another example, Image A may also contain imagery of POI4 (not shown). In this case, Image A may be stored as sub-entry 321 of POIl and a sub-entry of POI4 (not shown). Alternatively, Image A may be stored once, such as a sub-entry 321 of POI1 and linked to POI4, to avoid the need for duplicative storage. In yet another example, images may not be stored as sub-entries, but rather in another portion of the index or database, or in an entirely different database. The images may then be linked to entries in the database.

In some instances, an image may be segmented into parts with each part being stored as its own image. For instance, image recognition models, such as those described further herein, may identify objects in an image and separate the image data associated with an identified object or objects into its own image.

The gathered image data may be analyzed by the server computing device 110 to identify whether it includes any defined metadata, as shown in block 405 of FIG. 4. In the event the image data includes defined metadata, the defined metadata may be stored in association with the image data from which it was retrieved, as shown in block 407 of FIG. 4. For instance, and again referring to FIG. 3, the image data which was used to create sub-entry 321 of Image A may include defined metadata such as the file name of Image A and the location where Image A was captured. This defined metadata may be retrieved and stored in association with Image A in sub-entry 321, as illustrated by the “defined” designation of the metadata.

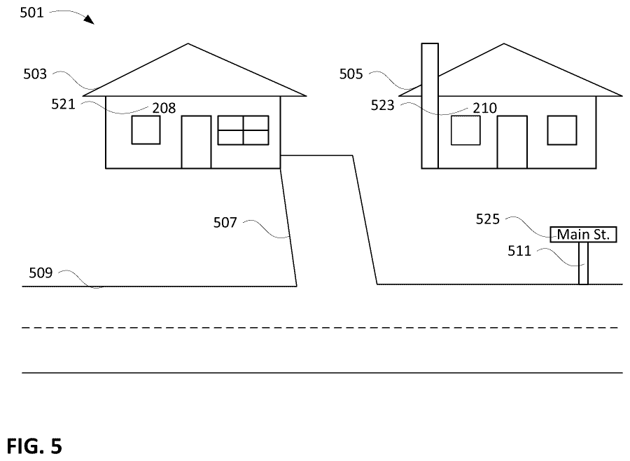

Metadata may be derived from the image data, as shown in block 409 of FIG. 4. In this regard, image data may be processed to identify content within an image, such as objects and texts within the image data. The identified objects and text can then be used to generate derived metadata for use in responding to queries. For example, image 501 shown in FIG. 5, may be processed and objects within the image 501 may be identified. Such objects include houses 503 and 505, driveway 507, and road 509. Metadata indicating image 501 includes the identified objects 503, 505, 507, and/or 509 may be generated. Additional metadata, such as data identifying the locations of the identified objects in the image 501 may also be derived. The derived metadata may be stored in association with the image data, as shown in block 411.

Referring to FIG. 3, metadata may be derived from Image B in sub-entry 331. The metadata associated with Image B may be stored in association with Image B and include a “derived” designation. Although FIG. 3 identifies the metadata in sub-entries 321 and 331 as being “defined” and/or “derived,” in practice the metadata may not be identified as being defined or derived.

Processing of image data to derive metadata may be performed using one or more image recognition models to identify the contents within the image data. The image recognition models may include machine perception, logo recognition, semantic segmentation etc., and other such image and text processing algorithms. For example, image recognition models may include 3D reconstruction and Structure-from-Motion (SfM), which are capable of fusing semantics across multiple images. 3D reconstruction and SfM may be used to reconcile the physical positions of detected objects within images with one another, correlating detections from different sources. For instance, 3D reconstruction and/or SfM may be used to position a sign object in images captured from different angles and perspectives, as well as at different times. SfM can also be used to more precisely localize photos in the world, by anchoring to previously-captured image data at the location. Text processing may include any variant of optical character recognition (OCR).

For example, FIG. 5 illustrates the content identified after using a machine perception algorithm, such as building detection and 3D reconstruction by fusing semantics across multiple imagery sets, including on image 501. Within image 501 are objects including houses 503 and 505, a driveway 507, and a road 509. Machine perception may be used to identify each of these objects. Similarly, if an image contains a logo or other marking associated with a business, individual, etc., logo recognition algorithms may be used to identify the logo in the image.

Some or all of the identified objects in an image may be used to derive metadata descriptive of the content of the image. For instance, derived metadata indicating image 501 includes houses, a road, and a driveway may be generated. The location of the identified objects in the real world, relative to other, nearby features or objects and/or in global coordinate frames relative to a datum, such as latitude/longitude/altitude or earth-centered, earth-fixed (ECEF), may be stored in the metadata or other such database.

The image recognition model may also identify textual content within the image data. For example, each house 503 and 505 has a house number 521 and 523, respectively. Moreover, street sign 511 has the street name 525. The image recognition model may use a text recognition and processing algorithm such as OCR and determine the house number 521 of house 503 is 208, the house number 523 of house 505 is 210, and the street name 525 is “Main St.” Based on this information, metadata may be generated that identifies road 509 as “Main St.” and the houses 503 and 505 as having addresses of 208 Main St. and 210 Main St., respectively. This additional metadata may be stored in the index in association with image 501. The location of textual data within images may also be stored as metadata. The location of the text in the real world, relative to features around it and/or in global coordinate frames relative to a datum, such as latitude/longitude/altitude or ECEF, may be stored in the metadata or other such database.

In some instances, defined and other derived metadata may be used to derive additional metadata. For example, and again referring to FIG. 5, the image data associated with image 501 may include a location of capture of the image in latitude/longitude coordinates. The location of capture information may be used to determine, based on other metadata within a database, such as database 301, that the location the image was captured was in Manhattan. Based on this additional information, the system may determine that houses 503 and 505 are both located in New York City in the State of NY. Thus, the system may determine that house 503's address is 208 Main St. New York, NY and house 505's address is 210 Main St. New York, NY. Metadata indicating the addresses of the houses may be generated and stored in association with image 501.

Any metadata that was derived or defined within the image data, and which can be shown within the image data from which it was derived or defined can be considered visually-verifiable metadata. Such visually-verifiable metadata may be marked as such in the database 301. For instance, and continuing the above example, the addresses of houses 503 and 505 may be considered visually-verifiable metadata, as the house numbers and street name are included in the image 501 from which the addresses of houses 521 and 523 were derived. Thus, the metadata including the addresses of houses 503 and 505 may be marked as being visually-verifiable

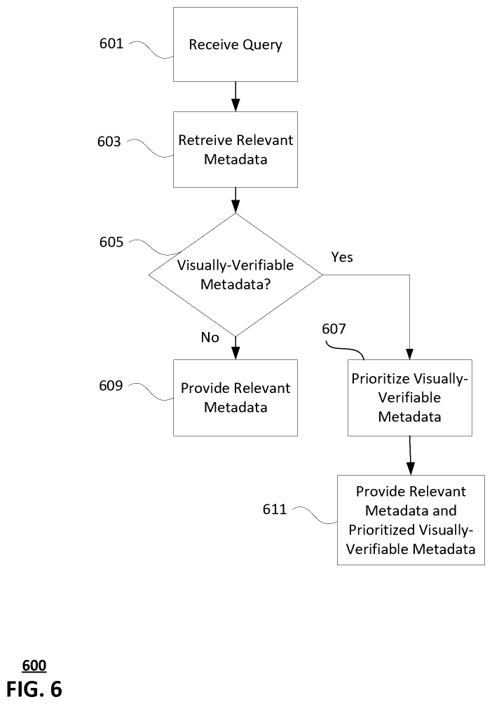

FIG. 6 is a flow diagram 600 that illustrates the process for providing visually-verifiable information about points of interest. In this regard, a query for information about a POI may be received by a server computing device, such as server computing device 110, as shown in block 601. The query may be submitted via a client computing device. For example, user 220 may submit a query to a map application executing on client computing 120. In some instances, an application may automatically submit a query for information about a point of interest. For example, a virtual assistant may submit a query for information about a location where an upcoming appointment for a user is located. In another example, a query may be received by the server computing device from another server computing device.

In response to the query, the server computing device may retrieve relevant metadata, as shown in block 603. The relevant metadata may be retrieved from a database, such as database 301 that stores data regarding to one or more POIs or other such information that may be provided by a map application in response to a query. Relevant metadata may be considered any type of data that includes information that may be responsive or otherwise material to the query. In some instances, the server computing device 110 may retrieve relevant data from locations other than database 301. For instance, the server computing device 110 may visit a website of a POI related to the query and collect relevant information about the POI from the website.

The server computing device 110 may determine whether the relevant metadata includes visually-verifiable metadata relevant to the retrieved data is available, as shown in block 605. Identification of visually-verifiable metadata may include analyzing the relevant metadata to see if any of the relevant metadata is marked as being visually-verifiable.

In the event no visually-verifiable metadata is identified, the server computing system may provide the retrieved relevant metadata in response to the query, as shown in block 609. The provided relevant data may include some or all of the retrieved relevant metadata.

In the event visually-verifiable metadata is identified within the retrieved relevant metadata, the visually-verifiable metadata may be prioritized, as shown in block 607. For instance, a query may result in many relevant metadata items being retrieved. However, only some of the retrieved metadata items may be identified as visually-verifiable metadata. The visually-verifiable metadata items may be prioritized over relevant metadata items that are not visually-verifiable, as visually-verifiable metadata may boost the confidence of the information corresponding to the metadata being correct. Visually-verifiable metadata that is old relative to the rate of change of a place may not be prioritized as much as newer visually-verifiable metadata Other factors, such as relevance to a query, may also be used to prioritize the metadata for returning in response to the query. In this regard, although some relevant metadata may be visually-verifiable, a piece of metadata that is not visually-verifiable may be prioritized for being more relevant to the query.

The relevant metadata, including the visually-verifiable metadata may be provided in response to the query, as shown in block 611. In some instances, the image or images associated with the visually-verifiable metadata may also be provided with the metadata, or may be provided in response to a subsequent request from the user or application. The visually-verifiable metadata may be annotated to bring a user's focus to the metadata. Annotation of the visually-verifiable metadata may include highlighting, circling, outlining, enlarging, or otherwise bringing attention and focus to the visually-verifiable metadata.

By providing the visually-verifiable metadata, the map application may return metadata that includes relevant information about one or more points of interest in response to the query. This metadata can be easily viewed and verified by a user. As a result, users may gain confidence that the map application, and the data it provides in response to queries, is accurate.

Although the steps of flow diagram 600 are described herein as being performed by a server computing device, any computing device, including a client computing device, may execute the steps.

### Example Use Cases

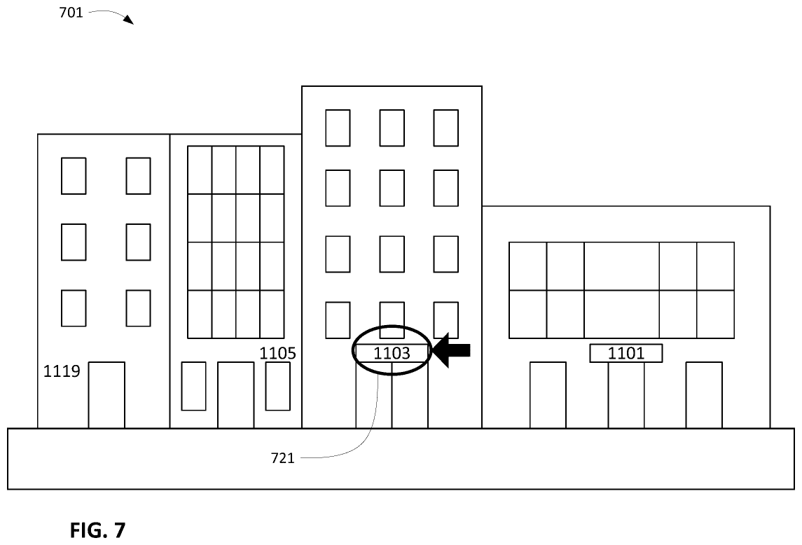

FIG. 7 illustrates an example use case in accordance with aspects of the disclosure. A user may enter an address query, “1103 Main St.,” into a map application on a user device, such as computing device 120. The map application may forward the request to a server computing device, such as server computing device 110. The server computing device 110 may determine that a database, such as database 301, includes visually-verifiable metadata corresponding to the number “1103” from an image 701 including the building located at 1103 Main St. The server computing device 110 may return the image along with the location where the visually-verifiable metadata was derived. The client computing device may output the image 701 with the location 721, corresponding to the street number on the side of the building, being annotated with a circle and arrow, as shown in FIG. 7. In some instances, the server computing device 110 may return an annotated image with the visually-verifiable metadata being identified or otherwise highlighted to the client computing device.

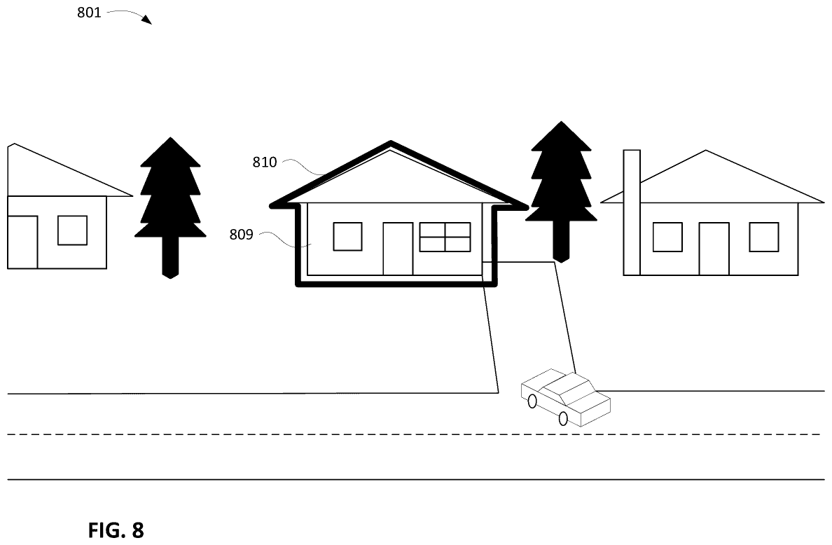

FIG. 8 illustrates another example use case where visually-verifiable metadata is outlined in response to a query. In FIG. 8, image data including an image 801 with visually-verifiable metadata 809 is identified in response to a query for the address corresponding to a house. The visually-verifiable metadata 809 includes imagery of the house within the image 801. The visually verifiable metadata 809 is outlined 810 and displayed or otherwise returned in response to the query.

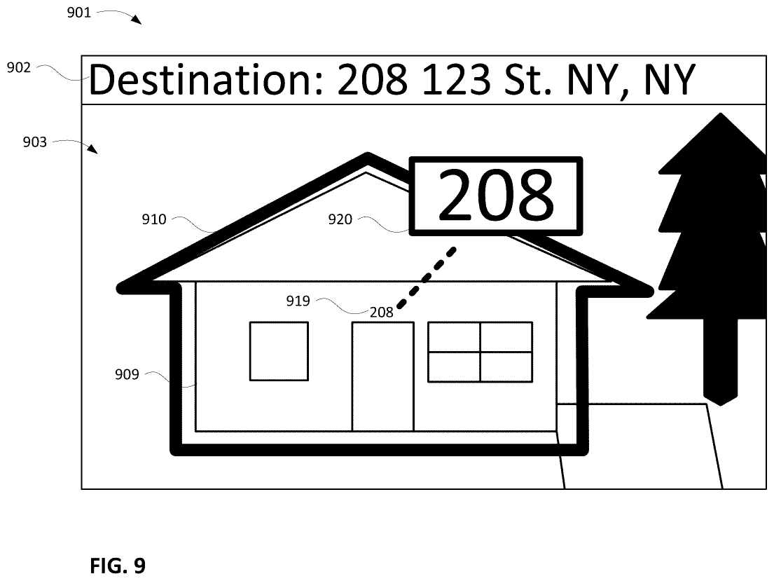

FIG. 9 illustrates an example use case where visually-verifiable metadata is displayed in a navigation application interface. The navigation application interface 901 includes a destination 902 and an image of the destination 903. The image of the destination 903 may include visually-verifiable metadata including a house 909 located at the address of the destination 902 and a house number 919 of the house. Both pieces of visually-verifiable metadata, including the house 909 and house number 919 are annotated. In this regard, the house 909 is outlined 910 and the house number 920 is enlarged for easier viewing by the user.

The image 903 may be processed in real-time. For example, the image 903 may be a frame of a video feed from a camera system of a vehicle. An image recognition model may identify content and textual content within the frame in real-time and highlight some or all of the visually-verifiable metadata within the frame, such as the house 909 and house number 919, as shown in FIG. 9. Processing may occur for each frame received from the video feed or at some predetermined time or number of frames.

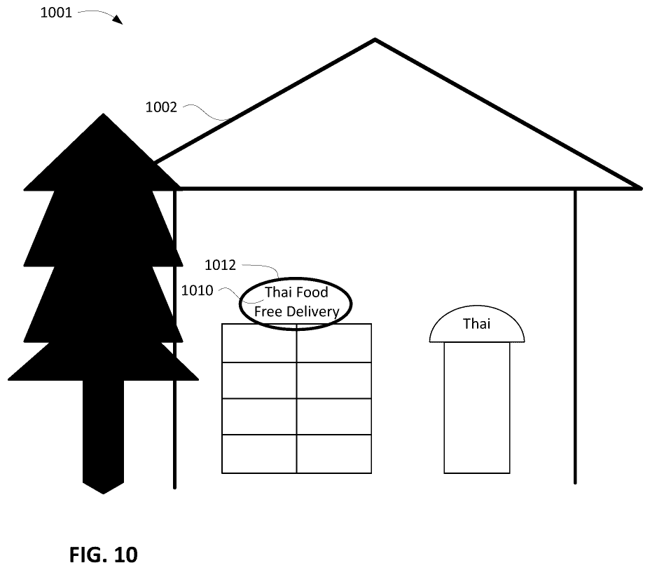

FIG. 10 illustrates another example use case where visually-verifiable metadata is provided in response to a query for a POI that satisfies a category. The query may be “Thai restaurant with delivery,” where the query includes a request for POIs (restaurants) that satisfy the categories of “Thai” and “delivery”. In response to the query, the system may identify a point of interest entry in the database that includes metadata that satisfies the categories of “Thai” restaurants and “delivery”. The POI entry may include an image 1001 with visually-verifiable metadata that shows the restaurant 1002 in the image 1001 is a Thai restaurant and that it offers free delivery. The visually-verifiable metadata 1010 may be annotated 1012 and returned in response to the query.

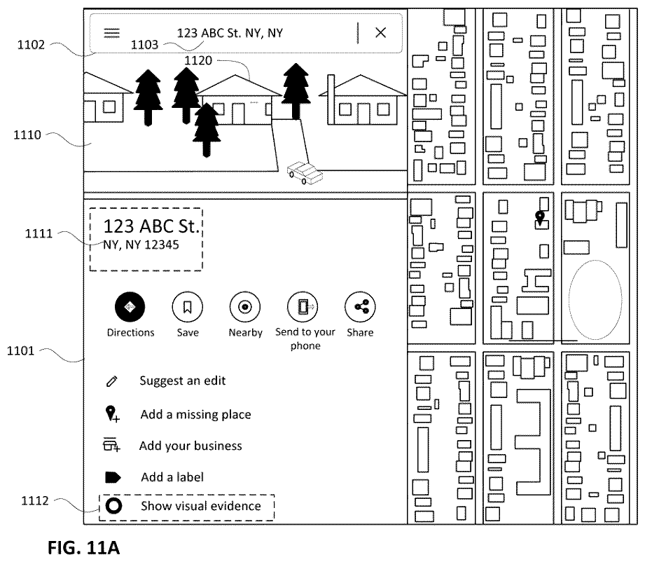

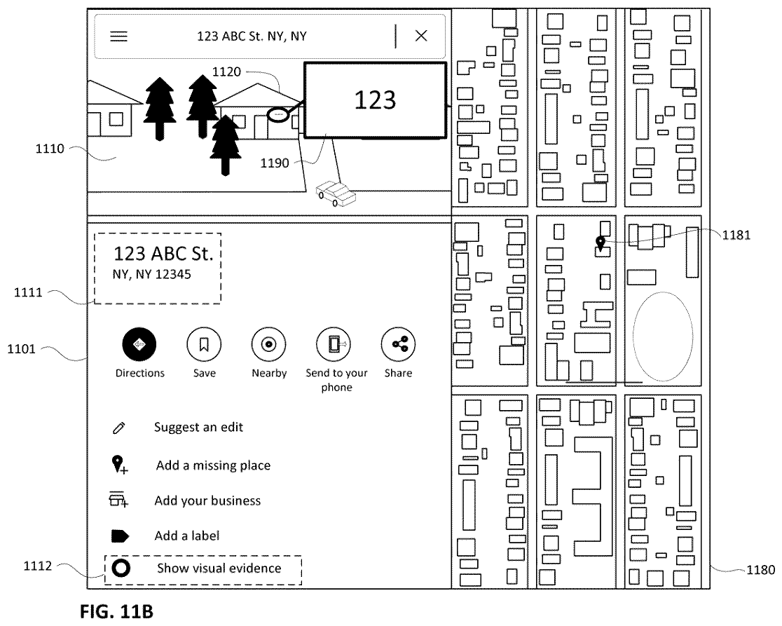

FIGS. 11A and 11B illustrate an example use case of the technology used within a search interface 1101. As shown in FIG. 11A, a user may enter a query for an address “123 ABC St. NY, NY” 1103 in a search bar 1102. In response to the query, the search interface 1101 may provide an image 1110 of the POI 1120 located at the address 1103 searched in the query as well as the location of the address on a map 1180, as indicated by pin 1181.

To provide confidence to the user that the image 1110 includes the POI 1120, and that the location of the address indicated on the map is accurate, the search interface may provide selectable input, including 1111 and 1112. These selectable inputs 1111, 1112, when selected, highlight the visually-verifiable metadata that confirms what is shown in the image and map is accurate. Selectable inputs 1111 and 1112 are merely for illustration purposes, any type of input may be provided in the search interface or other such interface.

Upon receiving a selection of one of the selectable icons, the visually-verifiable metadata may be highlighted. For example, and as shown in FIG. 11B, upon a user selecting selectable icon 1111 or 1112, the search interface 1101 may annotate the visually-verifiable metadata, including the house number 1190 for POI 1120 in the image 1110. In this example, the house number of POI 1120 is enlarged to make it easier for the user to see and to confirm that the POI 1120 is located at the address 1103 entered in the query.

Although the foregoing examples illustrated in FIGS. 7-12 describe the identification of visual-verifiable metadata as being performed by a server computing device, any computing device may perform these steps. For example, a map application executing on a client computing device, such as client computing device 120, may include a database, such as database 301. As such, the map application may access the database directly, without requiring the use of a server computing system.

The technology described herein is advantageous because it provides map applications with the ability to source and provides users with content that can be verified visually. By doing such, users are assured that the metadata provided in response to a query is accurate without the need for a user to manually confirm such results. Furthermore, this is done either automatically as part of a response to a single search query (e.g. as in FIGS. 7-10) or through selectable inputs which allow the user to cause additional visual information to be provided on demand at the same time as viewing search results (e.g. through selection of the selectable icon 1111 or 1112 in FIGS. 11A-11B, which may be selectable with e.g. a single touch or click). This makes it quick and easy for the user to interact with the application to cause relevant additional visual information about a point of interest to be provided.

The presence of visual verification, and its use in ranking results, may also incentivize users of the map application, as well as owners of POIs, such as merchants, to provide image data for POIs, to assure correct, and visually-verifiable information is provided for POIs. This is particularly true when that evidence must be gathered in places that are difficult to access or not open to the general public, such as indoor spaces belonging to a business.

Most of the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. As an example, the preceding operations do not have to be performed in the precise order described above. Rather, various steps can be handled in a different order, such as reversed, or simultaneously. Steps can also be omitted unless otherwise stated. In addition, the provision of the examples described herein, as well as clauses phrased as “such as,” “including” and the like, should not be interpreted as limiting the subject matter of the claims to the specific examples; rather, the examples are intended to illustrate only one of many possible embodiments. Further, the same reference numbers in different drawings can identify the same or similar elements.

1. A method for providing metadata, comprising:
receiving, by one or more processors, a query;
identifying, by the one or more processors, an image responsive to the query, wherein the image comprises visually-verifiable metadata corresponding to at least a portion of the query;
automatically annotating, by the one or more processors, the image to provide an indication of at least one location of the visually-verifiable metadata; and
providing for output, by the one or more processors, results responsive to the query, the results including the annotated image.

2. The method of claim 1, wherein the image includes imagery of one or more points of interest relevant to the query.

3. The method of claim 1, wherein the indication of at least one location of the visually-verifiable metadata comprises highlighting, circling, identifiers, outlining, or enlargement within the image.

4. The method of claim 1, wherein the query is a point of interest.

5. The method of claim 4, wherein the query is received from a navigation application or a search interface.

6. The method of claim 1, further comprising ranking, by the one or more processors, the results responsive to the query, based at least in part on availability of images responsive to the query including the visually-verifiable metadata.

7. The method of claim 1, further comprising:
identifying, by the one or more processors, relevant metadata responsive to the query; and
determining, by the one or more processors, based on the relevant metadata, the relevant metadata includes the visually-verifiable metadata.

8. A system for providing metadata, comprising:
one or more processors, the one or more processors configured to:
receive a query;
identify an image responsive to the query, wherein the image comprises visually-verifiable metadata corresponding to at least a portion of the query;
automatically annotate the image to provide an indication of at least one location of the visually-verifiable metadata; and
provide for output results responsive to the query, the results including the annotated image.

9. The system of claim 8, wherein the image includes imagery of one or more points of interest relevant to the query.

10. The system of claim 8, wherein the indication of at least one location of the visually-verifiable metadata comprises highlighting, circling, identifiers, outlining, or enlargement within the image.

11. The system of claim 8, wherein the query is a point of interest.

12. The system of claim 11, wherein the query is received from a navigation application or a search interface.

13. The system of claim 8, wherein the one or more processors are further configured to rank, based at least in part on availability of images responsive to the query including the visually-verifiable metadata, the results responsive to the query.

14. The system of claim 8, wherein the one or more processors are further configured to:
identify relevant metadata responsive to the query; and
determine, based on the relevant metadata, the relevant metadata includes the visually-verifiable metadata.

15. One or more non-transitory computer-readable media for storing instructions that, when executed by one or more processors, cause the one or more processors to perform operations comprising:
receiving a query;
identifying an image responsive to the query, wherein the image comprises visually-verifiable metadata corresponding to at least a portion of the query;
automatically annotating the image to provide an indication of at least one location of the visually-verifiable metadata; and
providing for output results responsive to the query, the results including the annotated image.

16. The one or more non-transitory computer-readable media of claim 15, wherein the image includes imagery of one or more points of interest relevant to the query.

17. The one or more non-transitory computer-readable media of claim 15, wherein the indication of at least one location of the visually-verifiable metadata comprises highlighting, circling, identifiers, outlining, or enlargement within the image.

18. The one or more non-transitory computer-readable media of claim 15, wherein the query is a point of interest.

19. The one or more non-transitory computer-readable media of claim 18, wherein the query is received from a navigation application or a search interface.

20. The one or more non-transitory computer-readable media of claim 15, wherein the operations further comprise ranking the results responsive to the query based at least in part on availability of images responsive to the query including the visually-verifiable metadata.
